(19) United States
(12) Patent Application Publication
(10) Pub. No.: US 2025/0217461 A1
(43) Pub. Date: Jul. 3, 2025

(54) INFORMATION PROCESSING SYSTEM, INFORMATION PROCESSING METHOD AND NON-TRANSITORY RECORDING MEDIUM

(71) Applicant: NEC Corporation, Minato-ku, Tokyo (JP)

(72) Inventor: Chisato OKAWA, Tokyo (JP)

(73) Assignee: NEC Corporation, Minato-ku, Tokyo (JP)

(21) Appl. No.: 18/851,218

(22) PCT Filed: Sep. 26, 2022
(86) PCT No.: PCT/JP2022/035744

§ 371 Date: Sep. 26, 2024

(51) Int. Cl. G06F 21/32; G06V 40/16; G06V 40/50; G07C 9/37

(52) U.S. Cl. CPC G06F 21/32; G06V 40/172; G06V 40/50; G07C 9/37

(57) ABSTRACT

An information processing system S1 is provided with: a first acquiring part 11 for acquiring a first image in which a first region including at least a part of a first area, which is adjacent to a second area via a gate, is imaged, an authenticating part 12 for authenticating a person included in the first image, a second acquiring part 13 for acquiring a second image in which a second region, which includes at least a part of the first area, is imaged, a determining part 14 for determining whether or not a person included in the second image is a person who has succeeded in authentication by the authenticating part 12, and a gate controlling part 15 for controlling opening and closing of the gate in response to a determination result by the determining part 14.

### TECHNICAL FIELD

This disclosure relates to technical fields of an information processing apparatus, an information processing method and a recording medium.

### BACKGROUND

A patent literature 1 discloses a technique improving authentication accuracy and authentication speed in face authentication by acquiring a first image in which a subject is imaged at a first distance, extracting a first biometric information group including biometric information of a first person detected from the first image from a registration biometric information group including biometric information of a plurality of registrants, and verifying biometric information of a second person detected from a second image, in which a subject is imaged at a second distance which is shorter than a distance to a subject in the first image, with biometric information included in the first biometric information group.

A patent literature 2 discloses a technique preventing an unauthorized user from passing through by acquiring biometric information of an authentication target in an authentication area, transmitting authentication request including the acquired biometric information to a server apparatus, detecting an intruder using a sensor for detecting an intruder into an own apparatus, determining whether or not an intruder is the same as the authentication target, and controlling a gate such that the authentication target passes through when authentication by the server apparatus is successful and the intruder is the same as the authentication target.

A patent literature 3 discloses a technique monitoring a position of an authentication-successful person in a monitoring area by using imaging results by a camera, wherein the monitoring area is at least a part of an imaged range imaged by the camera, and adjusting locking timing according to the position of the authentication-successful person by maintaining an unlock state if an monitoring result indicating that the authentication-successful person is in a near area which is close to a door is obtained when authentication is successful and an electronic lock is controlled to the unlock state, and by switching the electronic lock to a lock state if an monitoring result indicating that the authentication-successful person is in a far area which is far from the door is obtained.

A patent literature 4 discloses a technique improving authentication accuracy and authentication speed in face authentication by acquiring a first biometrics information group including biometric information of a first person detected from a first image imaged in a first area from a registration biometric information group including biometric information of a plurality of registrants, and verifying biometric information of a second person detected from a second image imaged in a second area, which is different from the first area, with biometric information included in the first biometric information group.

A patent literature 5 discloses a technique relating to a face authentication system for determining whether or not it allows a person to pass through by performing face authentication for the person passing through an authentication area, wherein the system sequentially acquires input images by imaging the authentication area, stores registered face images of users registered in advance, verifies a face image of a person extracted from input images with registered face images, authenticates the person as a user, allows the person to pass through when a size of an area indicating the authenticated person in an input image is larger than or equal to a predetermined size, does not allow to pass through when an authenticated person is at a position far from a camera even if the authenticated person is authenticated as a legitimate user by face authentication, then, allows to pass through when it is detected that the authenticated person closes to the camera.

### CITATION LIST

### Patent Literature

Patent Literature 1: International Patent Publication No. 2021/191966
Patent Literature 2: International Patent Publication No. 2021/186628
Patent Literature 3: Japanese Patent Application Laid Open No. 2021-130994
Patent Literature 4: Japanese Patent Application Laid Open No. 2020-057191
Patent Literature 5: Japanese Patent Application Laid Open No. 2015-001790

### SUMMARY

### Technical Problem

This disclosure is to provide a visitor management apparatus, a visitor management method and a recording medium aiming to improve techniques described in the prior art literatures.

### Solution to Problem

One aspect of an information processing system is provided with: a first acquiring means for acquiring a first image in which a first region including at least a part of a first area, which is adjacent to a second area via a gate, is imaged, an authenticating means for authenticating a person included in the first image, a second acquiring means for acquiring a second image in which a second region, which includes at least a part of the first area, is imaged, a determining means for determining whether or not a person included in the second image is a person who has succeeded in authentication by the authenticating means, and a gate controlling means for controlling opening and closing of the gate in response to a determination result by the determining means.

One aspect of an information processing method includes: acquiring a first image in which a first region including at least a part of a first area, which is adjacent to a second area via a gate, is imaged, authenticating a person included in the first image, acquiring a second image in which a second region, which includes at least a part of the first area, is imaged, determining whether or not a person included in the second image is a person who has succeeded in authentication, and controlling opening and closing of the gate in response to a determination result.

One aspect of a recording medium on which a computer program is recorded, wherein the computer program causes a computer to execute an information processing method including: acquiring a first image in which a first region including at least a part of a first area, which is adjacent to a second area via a gate, is imaged, authenticating a person included in the first image, acquiring a second image in which a second region, which includes at least a part of the first area, is imaged, determining whether or not a person included in the second image is a person who has succeeded in authentication, and controlling opening and closing of the gate in response to a determination result.

### BRIEF DESCRIPTION OF DRAWINGS

FIG. 1 is a block diagram showing configuration of an information processing system in a first embodiment.

FIG. 2 is a conceptual scheme of an information processing system in a second embodiment.

FIG. 3 is a block diagram showing configuration of the information processing system in the second embodiment.

FIG. 4 is a flowchart showing flow of authentication operation of the information processing system in the second embodiment.

FIG. 5 is a flowchart showing flow of gate controlling operation of the information processing system in the second embodiment.

FIG. 6 is a figure showing an example scene of the information processing system in the second embodiment.

FIG. 7 is conceptual scheme of an information processing system in a third embodiment.

FIG. 8 is a block diagram showing configuration of the information processing system in the third embodiment.

FIG. 9A is a flowchart showing flow of authentication operation of the information processing system in the third embodiment.

FIG. 9B is a flowchart showing a modified example of flow of authentication operation of the information processing system in the third embodiment.

FIG. 10 is a block diagram showing configuration of an information processing system in a fourth embodiment.

FIG. 11 is a flowchart showing flow of gate controlling operation of the information processing system in the fourth embodiment.

FIG. 12 is a flowchart showing flow of gate controlling operation of an information processing system in a fifth embodiment.

### DESCRIPTION OF EXAMPLE EMBODIMENTS

Hereinafter, embodiments of an information processing system, an information processing method and a recording medium will be described with referring to figures.

### 1: First Embodiment

First embodiments of an information processing system, an information processing method and a recording medium will be described. Hereinafter, first embodiments of the information processing system, the information processing method and the recording medium will be described by using an information processing system S1 to which first embodiments of the information processing system, the information processing method and the recording medium are applied.

### 1-1: Configuration of the Information Processing System S1

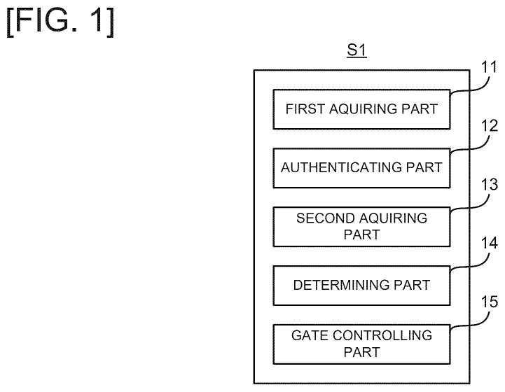

FIG. 1 is a block diagram showing the configuration of the information processing system S1 in the first embodiment. As shown in FIG. 1, the information processing system S1 is provided with a first acquiring part 11, an authenticating part 12, a second acquiring part 13, a determining part 14 and a gate controlling part 15.

The first acquiring part 11 acquires a first image in which a first region including at least a part of a first area, which is adjacent to a second area via a gate, is imaged. The authenticating part 12 authenticates a person included in the first image. The second acquiring part 13 acquires a second image in which a second region, which includes at least a part of the first area, is imaged. The determining part 14 determines whether or not a person included in the second image is a person who has succeeded in authentication by the authenticating part 12. The gate controlling part 15 controls opening and closing of the gate in response to a determination result by the determining part 14.

### 1-2: Technical Effect of the Information Processing System S1

Since the information processing system S1 in the first embodiment controls opening and closing of the gate in response to whether or not the person in the second 30 region is a person who has succeeded in authentication in the first region, it is possible to perform opening and closing control of the gate in response to authentication result of persons.

### 2: Second Embodiment

Next, second embodiments of an information processing system, an information processing method and a recording medium will be described. Hereinafter, second embodiments of the information processing system, the information processing method and the recording medium will be described by using an information processing system S2 to which second embodiments of the information processing system, the information processing method and the recording medium are applied.

### 2-1: Whole Configuration of the Information Processing System S2

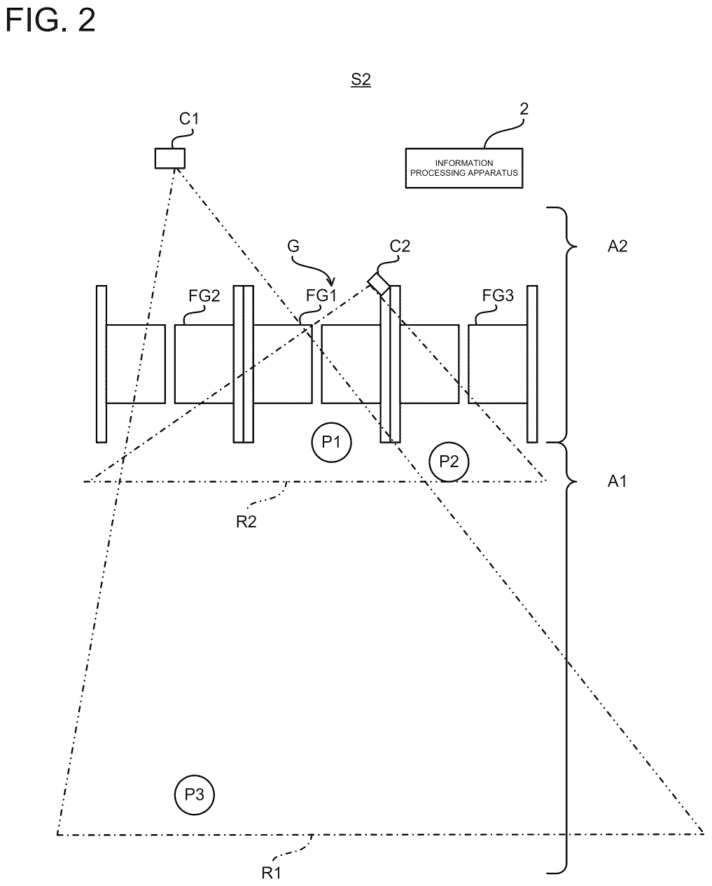

FIG. 2 is a conceptual scheme of the information processing system S2 in the second embodiment. As shown in FIG. 2, the information processing system S2 in the second embodiment may include a gate apparatus G as a gate, a first imaging apparatus C1 as a first imaging means, a second imaging apparatus C2 as a second imaging means, and an information processing apparatus 2.

In FIG. 2, an area below the gate apparatus G in the figure is called a first area A1, an area above the gate apparatus G in the figure is called a second area A2. In other words, the first area A1 and the second area A2 are adjacent to each other through the gate apparatus G.

The gate apparatus G is an apparatus can control passing of a target person P1, a target person P2 and a target person P3 (when target persons are not distinguished, each of persons is referred to as a target person P). The gate apparatus G includes a plurality of flapper gates FG.

The second area A2 is a destination of the target person P, and may be a restricted area in which only an authenticated target person P can enter. The gate is controlled to be open for the authenticated target person P, thereby the target person P can move from the first area A1 to the second area A2 through the gate.

The flapper gate FG is a plate-like member capable of controlling the target person P passing. Incidentally, in addition to or instead of the flapper gate FG, a gate bar, which is a rod-like member capable of controlling the target person P passing, may be used. A state of the flapper gate FG is controlled by the information processing apparatus 2 on the basis of an information processing result of the target person P by the information processing apparatus 2. Specifically, when authentication of the target person P by the information processing apparatus 2 is successful (i.e., it is determined that the target person P matches a registered person), the state of the flapper gate FG is controlled by the information processing apparatus 2 so that the state becomes an open state in which the target person P can pass through the flapper gate FG. The registered person may be, for example, a person who is permitted to enter the second area A2. On the other hand, when authentication of the target person P by the information processing apparatus 2 is failure (i.e., it is determined that the target person P does not match the registered person), the state of the flapper gate FG is controlled by the information processing apparatus 2 so that the state becomes a closed state in which the target person P can not pass through the flapper gate FG.

The flapper gate FG includes a flapper gate FG1, a flapper gate FG2 adjacent to one side of the flapper gate FG1, and a flapper gate FG3 adjacent to the other side of the flapper gate FG1. The target person P can pass through at least one of the flapper gate FG1, the flapper gate FG2, and the flapper gate FG3.

The first imaging apparatus C1 images a first range R1 including at least a part of the first area A1, and generates a first image. The first imaging apparatus C1 is placed in the second area A2. The first imaging apparatus C1 images an imaging target at the same size regardless of a distance from the first imaging apparatus C1 to the imaging target. The first imaging apparatus C1 may be a camera with a narrower angle of view than the second imaging apparatus C2. The first imaging apparatus C1 may also be capable of imaging a target person P who is relatively far from the gate apparatus G. Since the first imaging apparatus C1 images with a narrow angle of view from a position behind the gate apparatus G and away from the gate apparatus G, it is possible to also image a target person P behind the gate apparatus G with accuracy used for authentication. The second imaging apparatus C2 can image an image for face authentication of a target person P who may suddenly appear in front of the gate apparatus G contrary to expectations.

The second imaging apparatus C2 images a second range R2 including at least a part of the first area A1, and generates a second image. The second range R2 is closer to the gate apparatus G than the first range R1. In other words, an imaging target of the second imaging apparatus C2 may be a target person P who exists closer to the gate apparatus G than a target person P imaged by the first imaging apparatus C1. The second imaging apparatus C2 is placed at the gate apparatus G or near the gate apparatus G. FIG. 2 exemplifies a case in which the second imaging apparatus C2 is placed at the gate apparatus G. The second imaging apparatus C2 images an imaging target at a larger size as a distance from the second imaging apparatus C2 to the imaging target is shorter. The second imaging apparatus C2 may be a camera with a wider angle of view than the first imaging apparatus C1. Since the second imaging apparatus C2 images with a wider angle of view near the gate apparatus G, it is possible to image an image in which a size of the target person P1, who is in front of the gate apparatus G, and a size of the target person P2, who is behind of the target person P1, are significantly different. It is possible to easily identify which of target persons P1 and P2 is passing through the gate apparatus G by the image imaged by the second imaging apparatus C2.

The second imaging apparatus C2 may be a camera which images an image with a lower resolution than an image imaged by the first imaging apparatus C1. The second imaging apparatus C2 may be an infrared camera.

### 2-2: Configuration of the Information Processing Apparatus 2

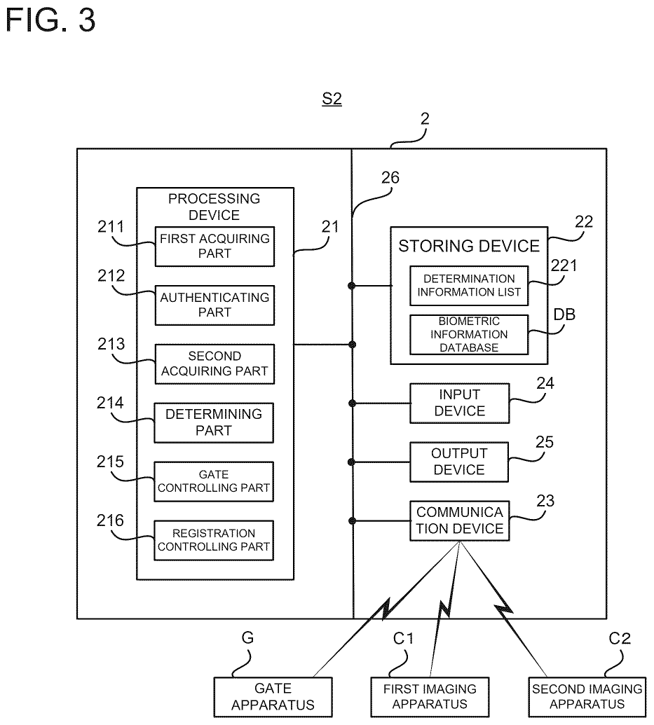

FIG. 3 is a block diagram of the information processing system S2 in the second embodiment. As shown in FIG. 3, the information processing apparatus 2 is provided with a processing device 21 and a storing device 22. Furthermore, the information processing apparatus 2 may be provided with a communications device 23, an input device 24 and an output device 25. However, the information processing apparatus 2 may not be provided with at least one of the communication device 23, the input device 24 and the output device 25. The processing device 21, the storage device 22, the communication device 23, the input device 24 and the output device 25 may be connected through a data bus 26.

The processing device 21 includes at least one of a CPU (Central Processing Unit), a GPU (Graphics Processing Unit) and an FPGA (Field Programmable Gate Array), for example. The processing device 21 reads computer programs. For example, the processing device 21 may read a computer program stored in the storing device 22. For example, the processing device 21 may read a computer program recorded on a computer readable and non-transitory recording medium by using a not shown recording medium reading device (e.g., the input device 24 described later) comprised in the information processing apparatus 2. The processing device 21 may acquire (in other words, download or read) a computer program from a not shown apparatus outside of the information processing apparatus 2 through the communication device 23 (or another communication device). The processing device 21 executes read computer programs. As a result, logical functional blocks for performing operation to be performed by the information processing apparatus 2 are realized in the processing device 21. In other words, the processing device 21 can function as a controller to realizing logical functional blocks for performing operation (i.e., process) to be performed by the information processing apparatus 2.

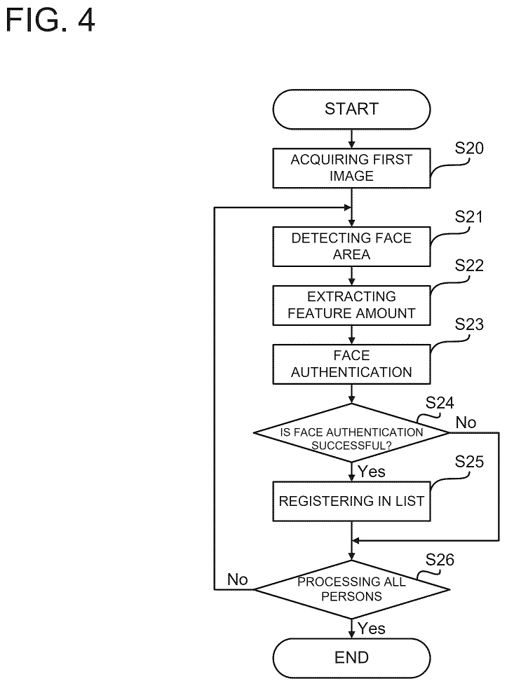

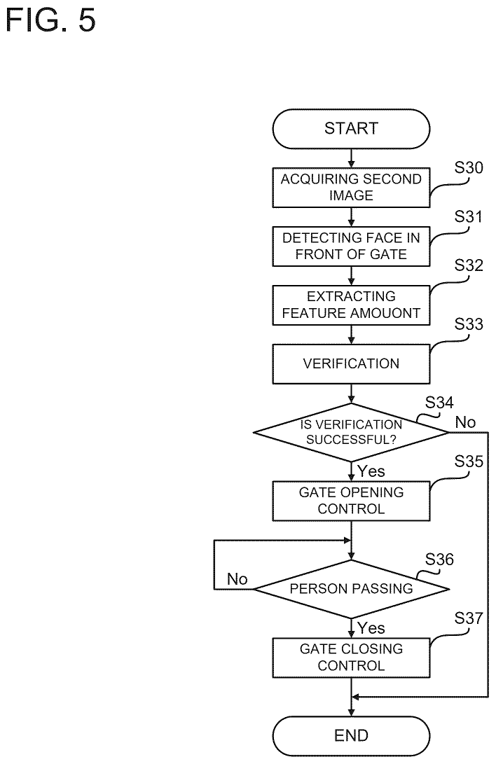

FIG. 3 shows one example of logical functional blocks realized in the processing device 21 for performing information processing operation. As shown in FIG. 3, in the processing device 21, a first acquiring part 211, which is one specific example of a “first acquiring means” described in supplementary notes described later, an authenticating part 212, which is one specific example of an “authenticating means” described in supplementary notes described later, a second acquiring part 213, which is one specific example of a “second acquiring means” described in supplementary notes described later, a determining part 214, which is one specific example of a “determining means” described in supplementary notes described later, a gate controlling part 215, which is one specific example of a “gate controlling means” described in supplementary notes described later, and a registration controlling part 216, which is one specific example of a “registration controlling means” described in supplementary notes described later, are realized. However, the processing device 21 may not be provided with the registration controlling part 216. Operations of the first acquiring part 211, the authenticating part 212, the second acquiring part 213, the determining part 214, the gate controlling part 215 and the registration controlling part 216, respectively, will be described later with referring to FIG. 4 and FIG. 5.

The storing device 22 can store desired data. For example, the storing device 22 may temporarily store computer programs executed by the processing device 21. The storing device 22 may temporarily store data temporarily used by the processing device 21 when the processing device 21 is executing a computer program. The storing device 22 may store data to be stored for a long time by the information processing apparatus 2. Wherein, the storing device 22 may include at least one of a RAM (Random Access Memory), a ROM (Read Only Memory), a hard disk device, an optical magnetic disk device, an SSD (Solid State Drive), and a disk array device. In other words, the storing device 22 may include non-transitory recording medium. The storing device 22 may include a determination information list 221. In the second embodiment, the determination information list 221 may be a storing means for temporarily storing biometric information of a target person P, who has succeeded in authentication, included in a first image. However, the storing device 221 may not include the determination information list 221. In this case, the determination information list 221 may be realized in another apparatus. Moreover, the storing device 22 may include a biometric information database DB. In the second embodiment, the biometric information database DB may be a database in which biometric information of registered persons are registered. The registered person may be a person who is permitted to enter the second area A2, for example. However, the storing device 22 may not include the biometric information database DB. In this case, the biometric information database DB may be realized in another apparatus.

The communication device 23 can communicate with an apparatus outside of the information processing apparatus 2 through a not shown communication network. The information processing apparatus 2 may perform transmitting and receiving signals with each of the gate apparatus G, the first imaging apparatus C1 and the second imaging apparatus C2 through the communication device 23.

The input device 24 is a device receiving information input to the information processing apparatus 2 from outside of the information processing apparatus 2. For example, the input device 24 may include an operation device (e.g., at least one of a keyboard, a mouse and a touch panel) which can be operated by an operator of the information processing apparatus 2. For example, the input device 24 may include a reading device, which can read information recorded, as data, on a recording medium being able to externally attach to the information processing apparatus 2.

The output device 25 is a device outputting information to outside of the information processing apparatus 2. For example, the output device 25 may output information as images. In other words, the output device 25 may include a display device (so-called display) which can display an image indicating information desired to output. For example, the output device 25 may output information as sound. In other words, the output device 25 may include a sound device (so-called speaker) which can output sound. For example, the output device 25 may output information to papers. In other words, the output device 25 may include a printing device (so-called printer) which can print desired information to papers.

### 2-3: Information Processing Operation Performed by the Information Processing Apparatus 2

Next, information processing operation performed by the information processing apparatus 2 will described with referring to FIG. 4 and FIG. 5. FIG. 4 is a flowchart showing flow of authentication operation performed by the information processing apparatus 2 in the second embodiment. FIG. 5 is a flowchart showing flow of gate controlling operation performed by the information processing apparatus 2 in the second embodiment.

### [Authentication Operation]

Operation from the “START” to the “END” shown in FIG. 4 may be operation relating to a single first image. For example, when the first imaging apparatus C1 images a moving image, the operation from the “START” to the “END” shown in FIG. 4 may be operation for each flame image. As shown in FIG. 4, the first acquiring part 211 acquires a first image, in which the first range R1 is imaged (step S20). The first range R1 includes at least a part of the first area A1 which is adjacent to the second area A2 through the gate apparatus G. The first acquiring part 211 may acquire the first image, which is generated by the first imaging apparatus C1 imaging the first range R1, through the communication device 23. In the second embodiment, authentication may be face authentication by using a face image. The first range R1 may be a face authentication area in which face authentication is performed.

The first acquiring part 211 detects a face area of the target person P included in the first image (step S21).

The first acquiring part 211 extracts characteristic information of a face (also called “feature amount”) from an image of the face area (step S22). The feature amount may be an example of biometric information of the target person P. The authenticating part 212 authenticates the target person P included in the first image (step S23). The authenticating part 212 may authenticate the target person P by verifying the feature amount extracted in the step S22 with feature amounts registered in the biometric information database DB.

The registration controlling part 216 determines whether or not the authentication is successful (step S24). When the authentication is successful, the registration controlling part 216 registers the feature amount, as the biometric information of the target person P, into the determination information list 221 (step S25).

When a plurality of target persons P are included in the first image, the processing device 21 performs authentication process for all of the plurality of target persons P included in the first image. The first acquiring part 211 determines whether or not the authentication process for all of the plurality of target persons P is performed (step S26). When the authentication process for all of the plurality of target persons P is performed (step S26: Yes), operation relating to the single first image is ended. When there is a target person P for whom authentication process is not performed (step S26: No), return to the step S22.

Since the first imaging apparatus C1 images a target person P located relatively far from the gate apparatus G, the authenticating part 212 also authenticates the target person P located relatively far away. The authenticating part 212, for example, performs authentication for the target person P2 and the target person P3 in addition to the target person P1 located in front of the gate apparatus G from a time point at which the target person P2 and the target person P3 located relatively far away, thereby it is possible to decide whether or not the target person P is a target person who is permitted to pass through the gate apparatus G.

### [Gate Controlling Operation]

Operation from the “START” to the “END” shown in FIG. 5 may be operation relating to a single second image. For example, when the second imaging apparatus C2 images a moving image, the operation from the “START” to the “END” shown in FIG. 5 may be operation for each flame image. As shown in FIG. 5, the second acquiring part 213 acquires a second image, in which the second range R2 is imaged (step S30). The second region R2 includes at least a part of the first area A1. The second acquiring part 213 may acquire the second image, which is generated by the second imaging apparatus C2 imaging the second region R2, through the communication device 23. The second region R2 may be an unlock area in which it is determined whether or not an opening control for the gate apparatus G is performed. The second region R2 may be a region, in which it is possible to determine that a target person P passes through a specific flapper gate FG. The second region R2 may include a region in which the closest target person P to a flapper gate FG exists in the first area A1.

The second acquiring part 213 detects a face area of the target person P included in the second image (step S31). When a plurality of target persons P are included in the second image, the second acquiring part 213 detects a face area of the closest target person P to a flapper gate FG. The second acquiring part 213 may detect the largest face area from face areas included in the second image as the face area of the closest target person P to the flapper gate FG.

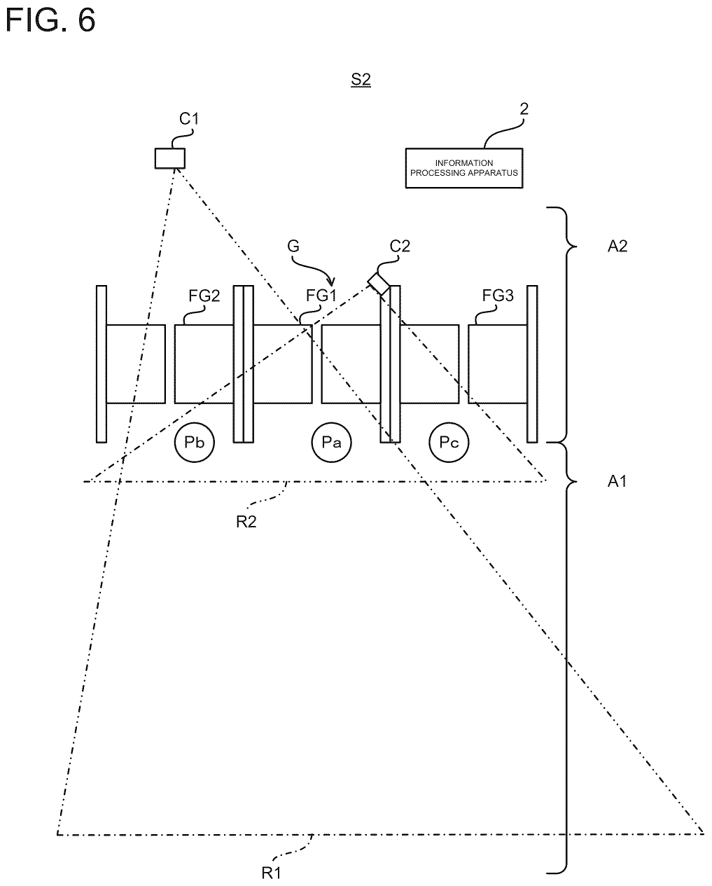

As exemplified in FIG. 6, when the gate apparatus G includes a plurality of flapper gates FG, the second acquiring part 213 may detect a face area of the closest target person P to a flapper gate FG for each flapper gate FG. Operation after the step S31 may be operation performed relating to a single flapper gate FG. For example, as shown in FIG. 6, it is assumed that there is a target person Pa in front of a flapper gate FG1; there is a target person Pb in front of a flapper gate FG2; and there is a target person Pc in front of a flapper gate FG3. In this case, the information processing apparatus 2 may perform controlling operation of the flapper gate FG1 for the target person Pa, controlling operation of the flapper gate FG2 for the target person Pb and controlling operation of the flapper gate FG3 for the target person Pc, respectively.

The second acquiring part 213 extracts characteristic information of a face (also called “feature amount”) from an image of the face area (step S32). The determining part 214 determines whether or not the target person P included in the second image is a target person P of whom authentication has been successful (step S33). The determining part 214 determines whether or not he/she is a target parson P of whom authentication by the authenticating part 212 has been successful, by verifying the feature amount extracted in the step S32 with feature amount registered in the determination information list 221 (step S34).

An image generated by the second imaging apparatus C2 may have poor image quality than an image generated by the first imaging apparatus C1. Since the second image is not an image used for verifying with a very large number of verification targets for specifying an individual, but is an image used for verifying with relatively small verification targets, the second image may be a relatively low-resolution image. Verification using the image generated by the second imaging apparatus C2 may have inferior accuracy than verification using the image generated by the first imaging apparatus C1. Verification operation performed by the determining part 214 may be smaller than verification operation performed by the authenticating part 212.

When he/she is a target parson P of whom authentication by the authenticating part 212 has been successful (step S34: Yes), the gate controlling part 215 controls the flapper gate FG to open (step S35).

The gate controlling part 215 determines whether or not the target person P passes through the flapper gate FG (step S36). When the target person P passes through the flapper gate FG (step S36: Yes), the gate controlling part 215 controls the flapper gate FG to close (step S37). The gate controlling part 215 repeats the determination of the step S36 until the target person P passes through the flapper gate FG.

When authentication by the authenticating part 212 is not successful (step S34: No), operation relating to a single second image is ended. In other words, the gate controlling part 215 controls opening/closing of a gate in response to a determination result by the determining part 214.

Incidentally, in the above description, the registration controlling part 216 registers a feature amount in the determination information list 221, wherein the registered feature amount may be the feature amount extracted in the step S22 or the feature amount registered in the biometric information database DB used in the authentication operation of the step S23. Alternatively, the registration controlling part 216 may register an image itself of a face area detected from the first image in the determination information list 221. When the image itself of the face area detected from the first image is registered in the determination information list 221, the second acquiring part 213 may extract a feature amount from the image of the face area registered in the determination information list 221. In this case, the feature-amount-extracting operation by the first acquiring part 211 and the feature-amount-extracting operation by the second acquiring part 213 may be a different operation from each other.

Moreover, if the second imaging apparatus C2 is an infrared camera, the information processing apparatus 2 may also perform an impersonation detection using an infrared image before or after the step S33, for example. By using an infrared image, it is possible to determine whether or not an image of a face area is such as a photo or a tablet screen. Furthermore, the information processing apparatus 2 may detect whether or not he/she has a fever from a temperature of a face surface by using an infrared image before or after of the step S33, for example.

### Modified Example

In the above-mentioned embodiment, the registration controlling part 216 registers the biometric information of the target person P included in the first image in the determination information list 221 when authentication by the authenticating part 212 is successful. As another example, the registration controlling part 216 may register the biometric information of the target person P included in the first image in the determination information list 221 when authentication by the authenticating part 212 is failed. In this case, in the step S34, the determining part 214 may verify the feature amount extracted in the step S32 with the feature amount registered in the determination information list 221, and may determine he/she is a target person P of whom authentication by the authenticating part 212 is failed when the verification is successful.

In other words, the registration controlling part 216 may register biometric information of the target person P included in the first image in the determination information list 221 in response to an authentication result by the authenticating part 212. The registration controlling part 216 may create a list of biometric information of a target person P of whom authentication is successful, or a list of biometric information of a target person P of whom authentication is failed.

### 2-4: Technical Effect of the Information Processing System S2

Since verification performed in front of a gate is verification with a few verification targets registered in the determination information list 221, the information processing system S2 in the second embodiment can perform the verification in a short time. Moreover, since confront operation with an authentication result by the authenticating part 212, a strict verification accuracy is not required, and the verification can be performed in a short time. Therefore, it is possible to shorten a time to wait for a target person P intending to pass through the gate.

Moreover, since an image used for the authentication operation is imaged by the first imaging apparatus C1 placed at the second area A2 and an image used for the determination operation is imaged by the second imaging apparatus C2 placed at the gate apparatus G or near the gate apparatus G, it is possible to use images suitable for operations.

If the first imaging apparatus C1 is a wide-angle camera, since a target person P located far away is imaged as a small figure, there is a case in which a face of the target person P can not be imaged with a required resolution for face authentication. On the other hand, since the first imaging apparatus C1 images a target person P in similar size regardless of a distance from the first imaging apparatus C1 to the target person P, face areas of all of target persons P included in the first image are images suitable for authentication, thereby it is possible to authenticate a target person P located far away.

If the second imaging apparatus C2 is a narrow-angle camera, since the target person P1 located in front of the gate and the target person P2 who is behind the target person P1 are projected in similar size to the second image, there is a case in which it is impossible to distinguish which the target person P1 or the target person P2 intends to pass through the gate. On the other hand, since the shorter a distance from the second imaging apparatus C2 to a target person P becomes, the larger a size of the target person P imaged by the second imaging apparatus C2 becomes, it is possible to immediately determine which target person P is the closest to the gate apparatus G, thereby it is possible to specify which target person P is in front of the flapper gate FG.

If contrary to expectations there is a target person P who appears in front of the flapper gate FG, it is possible to control the gate to open in a short time when the target person P has been determined to be able to pass through the gate by the authenticating part 212, thereby it is possible to suppress the target person P waiting and prevent target persons P, who intend to pass through the gate apparatus G, staying. In other words, the information processing apparatus 2 does not perform authentication after determining the target person P is a target of the gate control. The information processing apparatus 2 can make a target person P, who appears in front of the flapper gate FG, pass through the flapper gate FG regardless of movement of the target person P until he/she appears in front of the flapper gate FG.

Moreover, since the information processing apparatus 2 adopts a face image as biometric information, there is no need to adopt a special imaging device.

### 3: Third Embodiment

Third embodiments of an information processing system, an information processing method and a recording medium will be described. Hereinafter, third embodiments of the information processing system, the information processing method and the recording medium will be described by using an information processing system S3 to which third embodiments of the information processing system, the information processing method and the recording medium are applied.

### 3-1: Whole Configuration of the Information Processing System S3

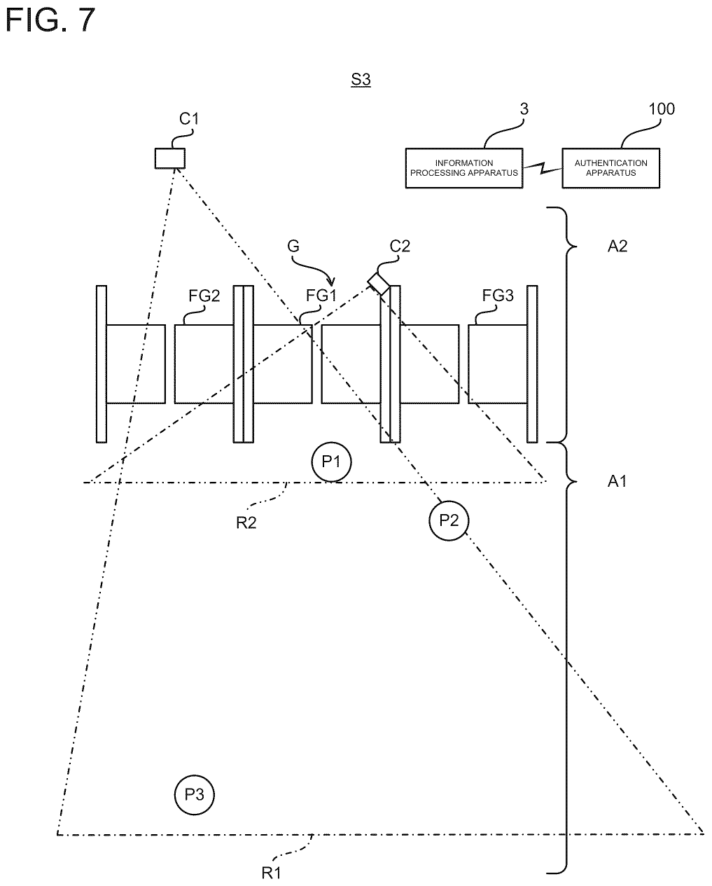

FIG. 7 is a conceptual scheme of the information processing system S3 in the third embodiment. As shown in FIG. 7, the information processing system S3 in the third embodiment may include a gate apparatus G, a first imaging apparatus C1, a second imaging apparatus C2, an information processing apparatus 3 and an authentication apparatus 100. Each of the gate apparatus G, the first imaging apparatus C1 and the second imaging apparatus C2 in the third embodiment may have the same feature as each of the gate apparatus G, the first imaging apparatus C1 and the second imaging apparatus C2 in the second embodiment.

The information processing apparatus 3 and the authentication apparatus 100 transmit and receive signals. FIG. 7 shows the single gate apparatus G, the single first imaging apparatus C1, the single second imaging apparatus C2 and the single information processing apparatus 3, but in the third embodiment, the information processing system S3 may include a plurality of gate control mechanism sets including the gate apparatus G, the first imaging apparatus C1, the second imaging apparatus C2 and the information processing apparatus 3. In this case, each information processing apparatus 3 may transmit and receive signals to and from the single authentication apparatus 100.

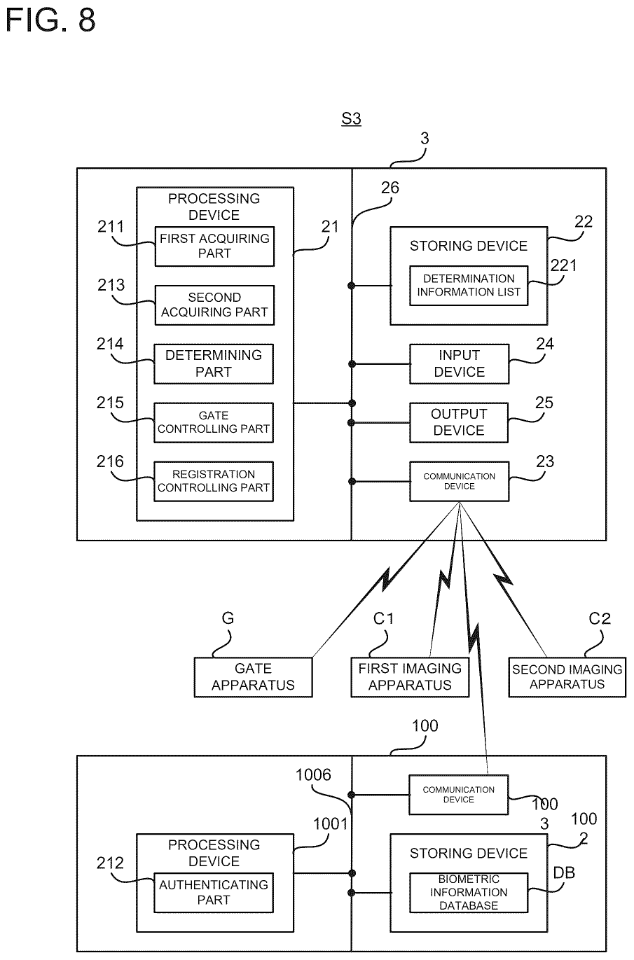

Configuration of the information processing apparatus 3 and configuration of the authentication apparatus 100 in the third embodiment will be described with referring to FIG. 8. FIG. 8 is a block diagram of the information processing system S3 in the third embodiment.

### 3-2: Configuration of the Information Processing Apparatus 3

As shown in FIG. 8, the information processing apparatus 3 in the third embodiment is provided with a processing device 21 and a storing device 22, similarly to the information processing apparatus 2 in the second embodiment. Furthermore, the information processing apparatus 3 may be provided with a communication device 23, an input device 24 and an output device 25, similarly to the information processing apparatus 2 in the second embodiment. However, the information processing apparatus 3 may not be provided with at least one of the communication device 23, the input device 24 and the output device 25. The information processing apparatus 3 in the third embodiment differs from the information processing apparatus 2 in the second embodiment in that the processing device 21 does not include the authenticating part 212. Other features of the information processing apparatus 3 may be the same as other features of the information processing apparatus 2 in the second embodiment. Therefore, hereinafter, a portion, which is different from each embodiment already described, will be described in detail, and other overlapping portions will be omitted from description as appropriate.

### 3-3: Configuration of the Authentication Apparatus 100

As shown in FIG. 8, the authentication apparatus 100 in the third embodiment is provided with a processing device 1001, a storing device 1002 and a communication device 1003. The processing device 1001, the storing device 1002 and the communication device 1003 may be connected through a data bus 1006.

The processing device 1001 includes at least one of a CPU (Central Processing Unit), a GPU (Graphics Processing Unit) and an FPGA (Field Programmable Gate Array), for example. The processing device 1001 reads computer programs. For example, the processing device 1001 may read a computer program stored in the storing device 1002. For example, the processing device 1001 may read a computer program recorded on a computer readable and non-transitory recording medium by using a not shown recording medium reading device comprised in the authentication apparatus 100. The processing device 1001 may acquire (in other words, download or read) a computer program from a not shown apparatus outside of the authentication apparatus 100 through the communication device 1003 (or another communication device). The processing device 1001 executes read computer programs. As a result, logical functional blocks for performing operation to be performed by the authentication apparatus 100 are realized in the processing device 1001. In other words, the processing device 1001 can function as a controller to realizing logical functional blocks for performing operation (i.e., process) to be performed by the authentication apparatus 100.

As shown in FIG. 8, an authenticating part 212 is realized in processing device 1001. The authenticating part 212 in the third embodiment may operate similarly to the authenticating part 212 realized in the processing device 21 provided in the information processing apparatus 2 in the second embodiment.

The storing device 1002 can store desired data. For example, the storing device 1002 may temporarily store computer programs executed by the processing device 1001. The storing device 1002 may temporarily store data temporarily used by the processing device 1001 when the processing device 1001 is executing a computer program. The storing device 1002 may store data to be stored for a long time by the authentication apparatus 100. Wherein, the storing device 1002 may include at least one of a RAM (Random Access Memory), a ROM (Read Only Memory), a hard disk device, an optical magnetic disk device, an SSD (Solid State Drive), and a disk array device. In other words, the storing device 1002 may include non-transitory recording medium.

The storing device 1002 may include a biometric information database DB. The biometric information database DB in the third embodiment may be the same as the biometric information database DB in the second embodiment.

The communication device 1003 can communicate with an apparatus outside of the authentication apparatus 100 through a not shown communication network. The authentication apparatus 100 may transmit and receive signals to and from the information processing apparatus 3 through the communication apparatus 1003.

### 3-4: Information Processing Operation Performed by the Information Processing System S3

### [Authentication Operation]

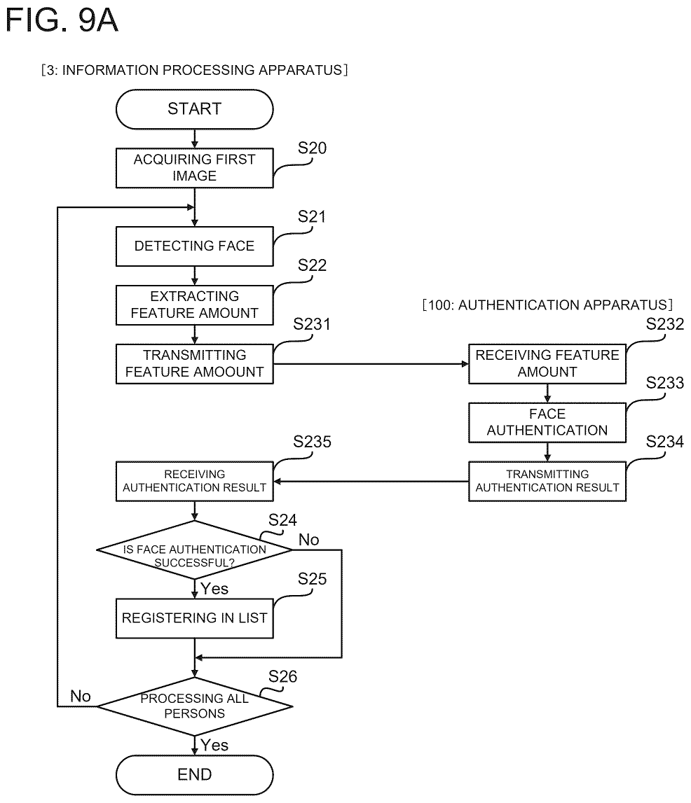

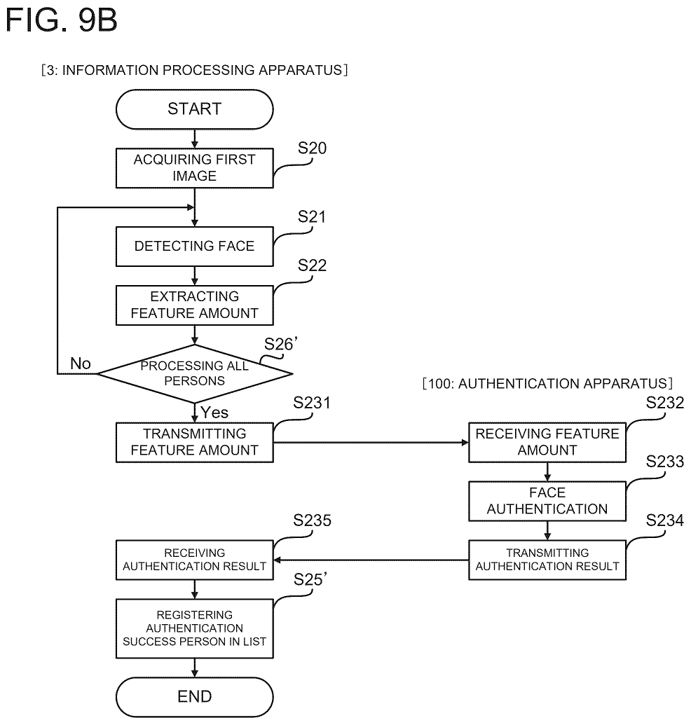

Next, information processing operation performed by the information processing S3 in the third embodiment will be described with referring to FIG. 9A and FIG. 9B. FIG. 9A and FIG. 9B are flowcharts showing flow of authentication operations performed by the information processing S3 in the third embodiment.

Operation from the “START” to the “END” shown in FIG. 9A and FIG. 9B may be operation relating to a single first image. For example, when the first imaging apparatus C1 images a moving image, the operation from the “START” to the “END” shown in FIG. 9A and FIG. 9B may be operation for each frame image.

As shown in FIG. 9A and FIG. 9B, the authentication operation in the third embodiment differs from the authentication operation in the second embodiment shown in FIG. 4 in the operation of the step S23. As shown in the FIG. 9A, a part of the authentication operation in the third embodiment is performed in the authentication apparatus 100.

### [Authentication Operation 1]

As shown in FIG. 9A, the first acquiring part 211 extracts a feature amount from an image of a face area in the step S22, and then the first acquiring part 211 transmits the face feature amount to the authentication apparatus 100 through the communication device 23 in the information processing apparatus 3 (step S231).

In the authentication apparatus 100, the authenticating part 212 receives the feature amount from the information processing apparatus 3 through the communication apparatus 1003 (step S232). In the authentication apparatus 100, the authenticating part 212 authenticates a target person P included in the first image (step S233). In the authentication apparatus 100, the authenticating part 212 transmits an authentication result of the target person P to the information processing apparatus 3 through the communication apparatus 1003 (step S234).

In the information processing apparatus 3, the registration controlling part 216 receives the authentication result from the authentication apparatus 100 through the communication apparatus 23 (step S235). The registration controlling part 216 determines whether or not face authentication has been successful (step S24).

### [Authentication Operation 2]

Authentication operation in the third embodiment may be performed in the flow shown in FIG. 9B. As shown in FIG. 9B, the first acquiring part 211 acquires a first image in which the first range R1 is imaged in the step S20, and then the first acquiring part 211 extracts a feature amount from each of images of face areas of all of target persons P included in the first image. In other words, operations of the step S21 and the step S22 are repeated until the determination of the step S26′ becomes Yes.

In the step S231, the first acquiring part 211 transmits all of extracted feature amounts to the authentication apparatus 100 through the communication apparatus 23. In the step S233, the authenticating part 212 performs authentication on all of received feature amounts. In the step S234, the authenticating part 212 transmits all of authentication results to the information processing apparatus 3. In the step S25′, the registration controlling part 216 registers a feature amount, as biometric information of a target person P of whom face authentication has been successful from all of target persons P included in the first image, in the determination information list 221.

In the case of the authentication operation 2, transmission/reception operation between the information processing apparatus 3 and the authentication apparatus 100 is performed once per a single first image, regardless of the number of target persons P included in the first image.

### [Gate Controlling Operation]

Gate controlling operation in the third embodiment is performed in the information processing apparatus 3. The gate controlling operation in the third embodiment may be the same operation as the gate controlling operation in the second embodiment. In other words, the gate controlling operation is completed in the information processing apparatus 3. Since there is no communication operation between the information processing apparatus 3 and the authentication apparatus 100, it is possible to perform the gate controlling operation in which processing velocity is required at high speed.

A purpose of use of the biometric information database DB stored in the storing device 1002 of the authentication apparatus 100 and a purpose of use the determination information list 221 stored in the storing device 22 of the information processing apparatus 3 are different from each other. Information registered in the biometric information database DB is information for specifying individuals. The information registered in the biometric information database DB may be used not only for authentication for opening control of the gate apparatus G, but also for edge servers that allow access to confidential information and for authentication for access permission to confidential information. For example, there may be one cloud server as the authentication apparatus 100 in a company and the cloud server has a biometric information database DB for managing personal information of employees. On the other hand, information registered in the determination information list 221 may not be registered in association with personal information such as name, employee number.

### 3-5: Technical Effect of the Information Processing System S3

The information processing system S3 in the third embodiment performs verification operation for authentication in the authentication apparatus 100 and performs the gate controlling operation in the information processing apparatus 3. Therefore, it is possible to perform gate control at high speed while ensuring security of information used for authentication. Moreover, since information registered in the determination information list 221 may not be registered in association with personal information such as name, employee number, risk in a case in which if the information registered in the determination information list 221 is leaked, is relatively low.

### 4: Fourth Embodiment

Fourth embodiments of an information processing system, an information processing method and a recording medium will be described. Hereinafter, fourth embodiments of the information processing system, the information processing method and the recording medium will be described by using a information processing system S4 to which fourth embodiments of the information processing system, the information processing method and the recording medium are applied.

### 4-1: Configuration of the Information Processing System S1

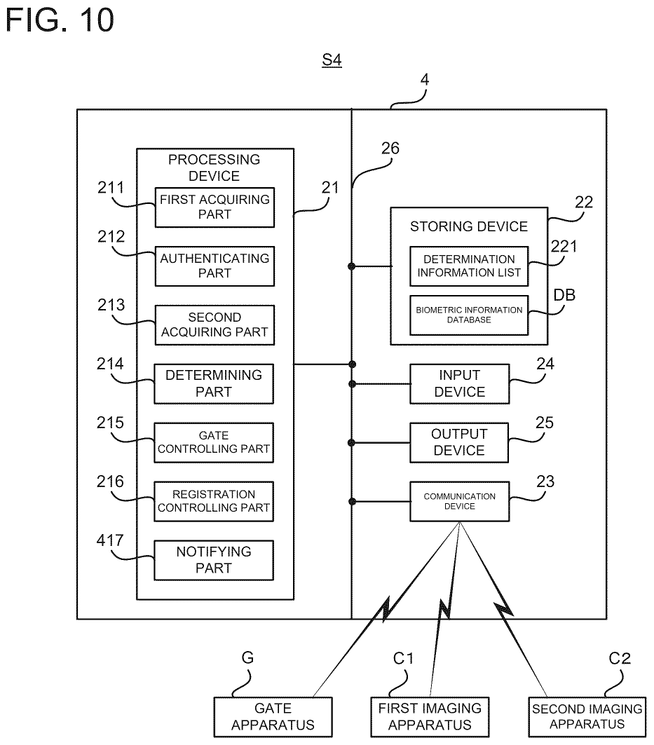

Configuration of the information processing system S4 in the fourth embodiment will be described with referring to FIG. 10. FIG. 10 is a block diagram showing the configuration of the information processing system S4 in the fourth embodiment. As shown in FIG. 10, the information processing system S4 in the fourth embodiment may be provided with a gate apparatus G, a first imaging apparatus C1, a second imaging apparatus C2 and an information processing apparatus 4, similarly to the information processing system S2 in the second embodiment.

As shown in FIG. 10, the information processing apparatus 4 in the fourth embodiment is provided with a processing device 21 and the storing device 22, similarly to the information processing apparatus 2 in the second embodiment. Furthermore, the information processing apparatus 4 may be provided with a communication device 23, an input device 24 and an output device 25, similarly to the information processing apparatus 2 in the second embodiment. However, the information processing apparatus 4 may not be provided with at least one of the communication device 23, the input device 24 and the output device 25. The information processing apparatus 4 in the fourth embodiment differs from the information processing apparatus 2 in the second embodiment in that the processing device 21 further includes a notifying part 417. The notifying part 417 may be a mechanism for output control of the output device 25. Other features of the information processing apparatus 4 may be the same as other features of the information processing apparatus 2 in the second embodiment. Therefore, hereinafter, a portion different from each embodiment already described will be described in detail, and other overlapping portions will be omitted from description as appropriate.

### 4-2: Information Processing Operations Performed by the Information Processing Apparatus 4

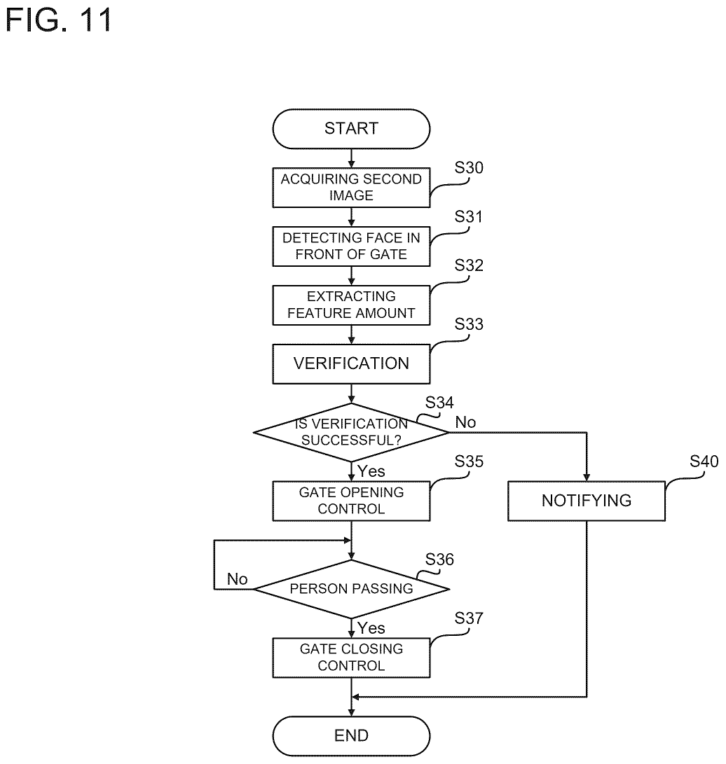

Information processing operation performed by the information processing apparatus 4 in the fourth embodiment will be described with referring to FIG. 11. FIG. 11 is a flowchart showing flow of the information processing operation performed by the information processing apparatus 4 in the fourth embodiment. As shown in FIG. 11, the operation when the determination of the step S34 is No differs from the gate controlling operation in the second embodiment shown in the flowchart of FIG. 5.

When a target person P of whom authentication has been successful is registered in the determination information list 221, if the determining part 214 determines the target person P is a target person of whom authentication by the authenticating part 212 is not successful, the notifying part 417 notifies that the authentication is not successful (step S40).

Alternatively, when a target person P of whom authentication has failed is registered in the determination informing list 221, if the determining part 214 determines the target person P is a target parson of whom authentication by the authenticating part 212 failed, the notifying part 417 may notify that the authentication failed.

In the fourth embodiment, the output device 25 may include a display apparatus capable of displaying image. The display apparatus may display an image indicating that authentication is not successful in accordance with control of the notifying part 417. In the fourth embodiment, the output device 25 may include a voice apparatus capable of outputting voice. The voice apparatus may output voice guide indicating that authentication is not successful in accordance with control of the notifying part 417. In the fourth embodiment, the output apparatus 25 may include a printing apparatus capable of printing desired information on papers. The printing apparatus may print that authentication is not successful on a paper in accordance with control of the notifying part 417, and may output.

Incidentally, the authentication operation in the fourth embodiment may be the same as the authentication operation in the second embodiment shown in the flowchart of FIG. 4.

Moreover, in the fourth embodiment, as the third embodiment, the authentication apparatus 100 is provided with the authenticating part 212 and the authentication operation may be performed in the authentication apparatus 100. In this case, the authentication operation in the fourth embodiment may be the same as the authentication operation in the third embodiment shown in the flowchart of FIG. 9A or FIG. 9B.

### 4-3: Technical Effect of the Information Processing System S4

The information processing system S4 in the fourth embodiment can inform a target person P that it is impossible to perform opening control for the gate apparatus G.

### 5: Fifth Embodiment

Next, fifth embodiments of an information processing system, an information processing method and a recording medium will be described. Hereinafter, fifth embodiments of the information processing system, the information processing method and the recording medium will be described by using an information processing system to which fifth embodiments of the information processing system, the information processing method and the recording medium are applied.

The information processing system in the fifth embodiment may have the same configuration as at least one of the information processing system S2 in the second embodiment to the information processing system S4 in the fourth embodiment described above. The information processing system in the fifth embodiment differs from the information processing system S2 in the second embodiment to the information processing system S4 in the fourth embodiment described above in operation of the registration controlling part 216.

### 5-1: Information Processing Operation Performed by the Information Processing System

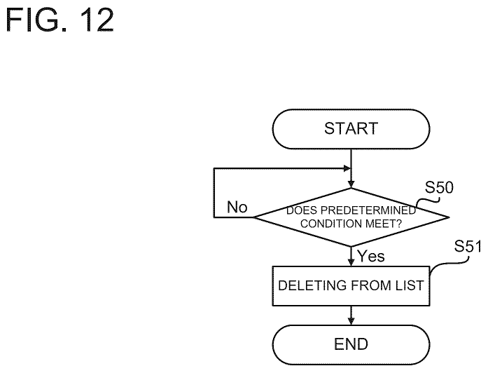

Information processing operation performed by the information processing system in the fifth embodiment will be described with referring to FIG. 12. FIG. 12 is a flowchart showing flow of the information processing operation performed by the information processing system in the fifth embodiment.

As shown in FIG. 12, the registration controlling part 216 determines whether or not a predetermined condition is satisfied (step S50). The predetermined condition may include a case in which a predetermined number of persons pass through the gate apparatus G after a target person P passes through the gate apparatus G. In other words, the step S50 may be later operation than the step S37 for a target person P. The predetermined number of persons may be 10, for example. The predetermined condition may include a case in which a predetermined time has elapsed after target person P has passed through the gate apparatus G. The predetermined time may be 10 seconds, for example. The predetermined condition may include a case in which a number of biometric information registered in the determination information list 221 exceeds a predetermined number. The predetermined number may be 100, for example. The predetermined condition may include a case in which a predetermined period has elapsed after being registered in the determination information list 221. The predetermined period may be 5 minutes, for example.

When the predetermined condition is satisfied (step S50: Yes), the registration controlling part 216 deletes biometric information of a corresponding target person P registered in the determination information list 221 (step S51). The registration controlling part 216 may repeat the operation of the step S50 until the predetermined conditional is satisfied.

In other words, the information registered in the determination information list 221 may be temporary information. Since the registration controlling part 216 performs deletion operation when the predetermined condition is satisfied, the information registered in the determination information list 221 can be set to a certain amount of range. Since biometric information registered in the determination information list 221 is limited to a certain amount of range, the determining part 214 may perform verification with a limited amount of biometric information. Since the number of verification targets is relatively small, it is possible to reduce processing load of the determining part 214. Moreover, operation time by the determining part 214 is shortened, thereby it is possible to prevent a target person P in front of the gate apparatus G from being made to wait.

### 5-2: Technical Effect of the Information Processing System

In the information processing system in the fifth embodiment, the determining part 214 can accurately verification with a small processing load.

### 6: Sixth Embodiment

Next, sixth embodiments of an information processing system, an information processing method and a recording medium will be described. Hereinafter, sixth embodiments of the information processing system, the information processing method and the recording medium will be described by using an information processing system to which sixth embodiments of the information processing system, the information processing method and the recording medium are applied.

The information processing system in the sixth embodiment may have the same configuration as at least one of the information processing system S2 in the second embodiment to the information processing system in the fifth embodiment described above. The information processing system in the sixth embodiment differs from the information processing system S2 in the second embodiment to the information processing system in the fifth embodiment described above in verification operation.

### 6-1: Verification Operation Performed by the Information Processing System

In the sixth embodiment, a threshold value of verification by the authenticating part 212 is larger than a threshold value of verification by the determining part 214. For example, even when a feature amount extracted from the first image used by the authenticating part 212 and a feature amount extracted from the first image used by the determining part 214 are the same, the threshold value of verification by the authenticating part 212 is set to be larger than the threshold value of verification by the determining part 214. In other words, the verification by the authenticating part 212 may be determined whether or not it is better similar to than the verification by the determining part 214.

Moreover, an algorithm used by the first acquiring part 211 may be different from an algorithm used by the second acquiring part 213. For example, the first acquiring part 211 may extract characteristic information of a face from an image of a face area by a feature extraction model (for example, a feature extraction model using a neural network) constructed by machine learning (for example, deep learning). On the other hand, the second acquiring part 213 may extract characteristic information of a face from an image of a face area by using a technique such as Eigenface. In other words, the first acquiring part 211 may use an advanced technique compared to the second acquiring part 213. In other words, the second acquiring part 213, compared to the first acquiring part 211 may be realized by a technique less processing burden or relatively inexpensive mechanisms. In this case, the characteristic information of a face used by the authenticating part 212 may be different from the characteristic information of a face used by the determining part 214.

### 6-2: Technical Effects of the Information Processing System

The information processing system in the sixth embodiment can perform processing suitable for the conditions, and processing burden can be reduced while performing the required processing.

### 7: Supplementary Note

In regard to embodiments described above, the following supplementary notes will be further disclosed.

### [Supplementary Note 1]

An Information Processing System Comprising:
a first acquiring means for acquiring a first image in which a first region including at least a part of a first area, which is adjacent to a second area via a gate, is imaged;
an authenticating means for authenticating a person included in the first image;
a second acquiring means for acquiring a second image in which a second region, which includes at least a part of the first area, is imaged;
a determining means for determining whether or not a person included in the second image is a person who has succeeded in authentication by the authenticating means; and
a gate controlling means for controlling opening and closing of the gate in response to a determination result by the determining means.

### [Supplementary Note 2]

The information processing system according to the supplementary note 1, further comprising:
a registration controlling means for registering biometric information of the person included in the first image in a determination information storing means in response to an authentication result by the authenticating means,
wherein the determining means verifies biometric information of the person included in the second image with biometric information registered in the determination information storing means, and determines whether or not a corresponding person is the person who has succeeded in authentication by the authenticating means.

### [Supplementary Note 3]

The information processing system according to the supplementary note 2, wherein the biometric information is a face image.

### [Supplementary Note 4]

The information processing system according to supplementary note 2 or 3, further comprising:
a notifying means for notifying that authentication is not succeeded when the determining means determines that the corresponding person is a person who does not succeed authentication by the authenticating means.

### [Supplementary Note 5]

The information processing system according to any one of supplementary notes 2 to 4, wherein
the registration controlling means deletes biometric information of the corresponding person registered in the determination information storing means when the gate controlling means performs open control for the gate and the corresponding person passes through the gate.

### [Supplementary Note 6]

The information processing system according to any one of supplementary notes 2 to 5, wherein
the authenticating means performs authentication by verifying the biometric information of the person included in the first image with biometric information registered in advance, and
a threshold value of verification by the authenticating means is large comparing with a threshold value of verification by the determining means.

### [Supplementary Note 7]

The information processing system according to any one of supplementary notes 1 to 6, further comprising:
a first imaging means for imaging the first region and generating the first image, wherein the first imaging means is placed in the second area; and
a second imaging means for imaging the second region and generating the second image, wherein the second imaging means is placed at the gate or near the gate.

### [Supplementary Note 8]

The information processing system according to the supplementary note 7, wherein
the first imaging means images an imaging target at an equivalent size regardless of a distance from the first imaging means to the imaging target, and
the second imaging means images the imaging target at a larger size as a distance from the second imaging means to the imaging target becomes shorter.

### [Supplementary Note 9]

The information processing system according to the supplementary note 2, wherein
the information processing system comprises an information processing apparatus and an authenticating apparatus,
the information processing apparatus comprises the first acquiring means, the registration controlling means, the second acquiring means, the determining means and the gate controlling means, and
the authenticating apparatus comprises the authenticating means.

### [Supplementary Note 10]

An information processing method including:
acquiring a first image in which a first region including at least a part of a first area, which is adjacent to a second area via a gate, is imaged;
authenticating a person included in the first image;
acquiring a second image in which a second region, which includes at least a part of the first area, is imaged;
determining whether or not a person included in the second image is a person who has succeeded in authentication; and
controlling opening and closing of the gate in response to a determination result.

### [Supplementary Note 11]

A recording medium on which a computer program is recorded, wherein the computer program causes a computer to execute an information processing method including: acquiring a first image in which a first region including at least a part of a first area, which is adjacent to a second area via a gate, is imaged, authenticating a person included in the first image, acquiring a second image in which a second region, which includes at least a part of the first area, is imaged, determining whether or not a person included in the second image is a person who has succeeded in authentication, and controlling opening and closing of the gate in response to a determination result.

At least a part of components of each of the above-mentioned embodiments may be combined with at least another part of components of each of the above-mentioned embodiments. A part of components of each of the above-mentioned embodiments may be not used. In addition, to the extent permitted by law, the disclosures of all documents (e.g., publications) cited in this disclosure above are incorporated by reference into this disclosure.

This disclosure can appropriately be changed within limits being not contrary to summary of inventions or ideas, that can be read from the scope of claims and all of the specification, an information processing system, an information processing method and a recording medium with such changes are also included in technical ideas of this disclosure.

### DESCRIPTION OF REFERENCE CODES

S1, S2, S3, S4 Information processing system
2, 3, 4 Information processing apparatus
C1 First imaging apparatus
C2 Second imaging apparatus
G Gate apparatus
FG Flapper gate
P Target person
A1 First area
A2 Second area
R1 First region
R2 Second region
100 Authentication apparatus
11, 211 First acquiring part
12, 212 Authenticating part
13, 213 Second acquiring part
14, 214 Determining part
15, 215 Gate controlling part
216 Registration controlling part
417 Notifying part
221 Determination information list
DB Biometric information database

What is claimed is:

1. An information processing system comprising:
at least one memory configured to store instructions; and
at least one processor configured to execute the instructions to:
acquire a first image in which a first region including at least a part of a first area, which is adjacent to a second area via a gate, is imaged;
authenticate a person included in the first image;
acquire a second image in which a second region, which includes at least a part of the first area, is imaged;
determine whether or not a person included in the second image is a person who has succeeded in authentication; and
control opening and closing of the gate in response to a determination result.

2. The information processing system according to claim 1, wherein the at least one processor is configured to execute the instructions to:
register biometric information of the person included in the first image in a determination information storing means in response to an authentication result,
verify biometric information of the person included in the second image with biometric information registered in the determination information storing means, and
determine whether or not a corresponding person is the person who has succeeded in authentication.

3. The information processing system according to claim 2, wherein
the biometric information is a face image.

4. The information processing system according to claim 2, wherein the at least one processor is configured to execute the instructions to:
notify that authentication is not succeeded when it is determined that the corresponding person is a person who does not succeed authentication.

5. The information processing system according to claim 2, wherein
the at least one processor is configured to execute the instructions to delete biometric information of the corresponding person registered in the determination information storing means when open control for the gate is performed and the corresponding person passes through the gate.

6. The information processing system according to claim 2, wherein
the at least one processor is configured to execute the instructions to perform authentication by verifying the biometric information of the person included in the first image with biometric information registered in advance, and
a threshold value of verification by using the first image is large comparing with a threshold value of verification by using the second image.

7. The information processing system according to claim 1, further comprising:
a first imaging means for imaging the first region and generating the first image, wherein the first imaging means is placed in the second area; and
a second imaging means for imaging the second region and generating the second image, wherein the second imaging means is placed at the gate or near the gate.

8. The information processing system according to claim 7, wherein
the first imaging means images an imaging target at an equivalent size regardless of a distance from the first imaging means to the imaging target, and
the second imaging means images the imaging target at a larger size as a distance from the second imaging means to the imaging target becomes shorter.

9. The information processing system according to claim 2, wherein
the information processing system comprises an information processing apparatus and an authenticating apparatus,
the information processing apparatus comprises at least one memory configured to store instructions, and at least one processor configured to execute the instructions to: acquire the first image in which the first region including at least a part of the first area, which is adjacent to the second area via the gate, is imaged, register biometric information of the person included in the first image in the determination information storing means in response to the authentication result, acquire the second image in which the second region, which includes at least a part of the first area, is imaged, determine whether or not a person included in the second image is a person who has succeeded in authentication, and control opening and closing of the gate in response to a determination result; and
the authenticating apparatus comprises at least one memory configured to store instructions, and at least one processor configured to execute the instructions to: authenticate the person included in the first image.

10. An information processing method including:
acquiring a first image in which a first region including at least a part of a first area, which is adjacent to a second area via a gate, is imaged;
authenticating a person included in the first image;
acquiring a second image in which a second region, which includes at least a part of the first area, is imaged;
determining whether or not a person included in the second image is a person who has succeeded in authentication; and
controlling opening and closing of the gate in response to a determination result.

11. A non-transitory recording medium on which a computer program is recorded, wherein the computer program causes a computer to execute an information processing method including: acquiring a first image in which a first region including at least a part of a first area, which is adjacent to a second area via a gate, is imaged, authenticating a person included in the first image, acquiring a second image in which a second region, which includes at least a part of the first area, is imaged, determining whether or not a person included in the second image is a person who has succeeded in authentication, and controlling opening and closing of the gate in response to a determination result.

12. The information processing system according to claim 3, wherein the at least one processor is configured to execute the instructions to:
notify that authentication is not succeeded when it is determined that the corresponding person is a person who does not succeed authentication.

13. The information processing system according to claim 3, wherein
the at least one processor is configured to execute the instructions to delete biometric information of the corresponding person registered in the determination information storing means when open control for the gate is performed and the corresponding person passes through the gate.

14. The information processing system according to claim 4, wherein
the at least one processor is configured to execute the instructions to delete biometric information of the corresponding person registered in the determination information storing means when open control for the gate is performed and the corresponding person passes through the gate.

15. The information processing system according to claim 12, wherein
the at least one processor is configured to execute the instructions to delete biometric information of the corresponding person registered in the determination information storing means when open control for the gate is performed and the corresponding person passes through the gate.

16. The information processing system according to claim 3, wherein
the at least one processor is configured to execute the instructions to perform authentication by verifying the biometric information of the person included in the first image with biometric information registered in advance, and
a threshold value of verification by using the first image is large comparing with a threshold value of verification by using the second image.

17. The information processing system according to claim 4, wherein
the at least one processor is configured to execute the instructions to perform authentication by verifying the biometric information of the person included in the first image with biometric information registered in advance, and
a threshold value of verification by using the first image is large comparing with a threshold value of verification by using the second image.

18. The information processing system according to claim 5, wherein
the at least one processor is configured to execute the instructions to perform authentication by verifying the biometric information of the person included in the first image with biometric information registered in advance, and
a threshold value of verification by using the first image is large comparing with a threshold value of verification by using the second image.

19. The information processing system according to claim 12, wherein
the at least one processor is configured to execute the instructions to perform authentication by verifying the biometric information of the person included in the first image with biometric information registered in advance, and
a threshold value of verification by using the first image is large comparing with a threshold value of verification by using the second image.

20. The information processing system according to claim 13, wherein
the at least one processor is configured to execute the instructions to perform authentication by verifying the biometric information of the person included in the first image with biometric information registered in advance, and
a threshold value of verification by using the first image is large comparing with a threshold value of verification by using the second image.
